(19) United States
(12) Patent Application Publication
(10) Pub. No.: US 2026/0297340 A1
(43) Pub. Date: Oct. 1, 2026

(54) USE OF POLYETHER SILOXANES AS PROCESSING AIDS FOR MELT GRANULATION

(71) Applicant: Evonik Operations GmbH, Essen (DE)

(72) Inventors: René Hänsel, Dorsten (DE); Phillip James, Pembrokeshire (GB); Oliver Erpeldinger, Wuelfrath (DE)

(73) Assignee: Evonik Operations GmbH, Essen (DE)

(21) Appl. No.: 19/489,433

(22) PCT Filed: Jun. 7, 2024
(86) PCT No.: PCT/EP2024/065716

§ 371 Date: Dec. 2, 2025

(30) Foreign Application Priority Data
Jun. 22, 2023 (EP) 23180941.9

(51) Int. Cl. C09D 5/16; C01B 17/02; C08G 77/46; C09D 183/12

(52) U.S. Cl. CPC C09D 5/1675; C01B 17/0221; C01B 17/0237; C08G 77/46; C09D 183/12

(57) ABSTRACT

Polyether siloxanes having less than 20 silicon atoms can be used as a release agent or release agent constituent in melt granulation. Melt granulates can be obtained by a process producing these melt granulates using these polyether siloxanes.

The present invention is in the field of melt granulation. The invention especially relates to the use of polyether siloxanes comprising less than 20 silicon atoms as a release agent or release agent constituent in melt granulation, to a process for producing melt granulates using these polyether siloxanes and to melt granulates obtainable by this use/this process.

Many industrial chemical processes generate melts. For example large amounts of liquid sulfur are formed from the so-called Claus process in refineries. Nowadays, various processes are available for bringing the liquid melt into a handleable and solid form. The molten products are converted with an application device into suitable shapes such as balls, flakes, pastilles or other shapes, preferably uniform shapes, preferably uniform, ideally spherical shapes (cooling belt plants). In the often continuous processes the industry pays special attention to cleanliness of the conveying means, which are preferably steel conveyor belts, and to good release of the shaped bodies from the conveying means in order that the process can run continuously for prolonged periods In addition, good meterability of the products and inexpensive and clean packaging of the products are demanded. A homogeneous shape and size of the shaped bodies, this requiring good release of the products from the conveyor belts, is especially important in order for these products to be amenable to further transportation and to be precisely meterable at a later stage. If the shape of the melt granulates has corners and edges these can break to cause dusts, especially in sulfur pelletization. Furthermore, such bodies are unwanted since they are not precisely meterable in downstream processes.

This solidification of the melts often employs the technology of steel belt coolers. This comprises continuously cooling and solidifying the melt. Different technologies may be used to achieve a very wide variety of shapes of particular sizes. Perforated plates are an older technology. In this case, a sulfur melt from the Claus process is passed through one or more perforated plates into a prilling container filled with water. Corresponding processes for producing sulfur granulates are described for example in U.S. Pat. No. 3,637,351 and EP 0064311 A1.

DE 2928401 A1 likewise describes a process for granulation of sulfur where molten sulfur is placed on a metal carrier and cooled until solidification, wherein application of the molten sulfur onto the metal carrier is preceded here by application of a composition comprising a solvent, organic titanate and a liquid carboxy-functional siloxane.

A technology that is widely used today is the solidification of sulfur melts using steel belt coolers and the so-called Rotoformer® (Rotoform System), as marketed for example by IPCO (formerly Sandvik Process Systems). The molten sulfur is supplied at a temperature of 125° C. to 145° C. to a Rotoformer® which uniformly applies said sulfur in droplet form to a steel belt whose underside is water-cooled using spray jets for example or passed through a water bath. In this process too, efforts are made to ensure good release of the shaped bodies and a uniform, ideally spherical shape of the melt granulates. The principle of this process is described for example in U.S. Pat. Nos. 6,398,989 and 4,279,579.

Especially the granulation of sulfur by the different processes for producing particular melt granulates, for example pastilles, requires the use of release agents to prevent possible adhesion to steel belts or other conveying means. The release agents additionally have a positive effect on the shape of the melt granulates, thus improving subsequent packaging and further use (precise metering). A frequently employed release agent is a silicone oil for example. GB 1537888 describes the use of silicone oils having a viscosity of 20 cSt to 50 cSt, from Dow Corning for example. This fluid is marketed under the trade name DOW CORNING® 200 FLUID, 20 cSt. The release agent is dispersed here in the molten sulfur and facilitates pelletization which is carried out on a cooled steel belt. One disadvantage of this technology is that the silicone needs to be dispersed in the sulfur for this purpose. Since the silicone oil is a liquid which is completely incompatible with water, as used for cooling and cleaning of the steel belts, the plant suffers from soiling and greasy residues which have an adverse effect on release of the shaped bodies from the steel belt cooler. An improvement was achieved with the use of silicone oil emulsions. Application of the emulsion by spraying or else immersion of the steel belts facilitates the process but adhering silicone residues on the belts are no longer re-emulsifiable and therefore also lead to soiling. Another disadvantage of emulsions is their low stability. Separation of the silicone oil from the aqueous phase often occurs at as low as 35° C., thus impeding the use thereof in refineries in hot countries, since the silicone oil often already separates in the storage or reservoir containers or in conveying means.

The above-described disadvantages were reduced through the use of polyether siloxanes, since polyether siloxanes are more hydrophilic compared to silicone oils. An often employed polyether siloxane for melt granulation is Tegopren® 5863 (Evonik). It has a polysiloxane chain comprising 48 silicon atoms and bears two polyethers having different molar masses but having the same mass fraction of ethylene oxide (about 40%) and propylene oxide (about 60%) on the siloxane chain. This polyether siloxane is water soluble and is applied as an aqueous solution. The disadvantages of emulsion stability at elevated temperature do not apply. However, one disadvantage is that the good release of the melt granulates does not remain constant but falls over time. In addition, the shape of the melt granulates can easily deviate from the optimal spherical shape. Curved melt granulates are obtained, whose flatter shaped bodies cause the above-described problems of breaking-off of the thinner edges and metering problems. Since the melt granulates need to be moved after their production (for example during transport, storage and further processing) low dust formation and low susceptibility to breakage of the melt granulates is preferred. A further disadvantage of this polyether siloxane is that its production, as effected by hydrosilylation from the corresponding unsaturated polyethers and an SiH-functional siloxane, requires the use of two different polyethers.

EP 2543630 A1 discloses polyether siloxanes which provide even better results than Tegopren® 5863 (Evonik) when used as a release agent or release agent constituent for melt granulation. These polyether siloxanes described therein comprise a polysiloxane chain having at least 20 silicon atoms and bear three different polyethers on this polysiloxane chain. These polyether siloxanes result in very easy release of the melt granulates, while release performance does not deteriorate even after 5 minutes. In addition no stubborn residues are formed on the apparatus, for example on the steel cooling belt, when these polyether siloxanes are used. The obtained melt granulates also have a uniform spherical shape. Deviations from the desired spherical shape are however possible, even if only to a very small extent. A further disadvantage of these polyether siloxanes is that their production, as effected by hydrosilylation from the corresponding unsaturated polyethers and with the corresponding SiH-functional siloxanes, requires the use of three different polyethers.

It is accordingly an object of the present invention to provide compounds for use as a release agent or release agent constituent in melt granulation which overcome at least one disadvantage of the prior art.

It is specifically an object of the present invention to provide compounds for use as a release agent or release agent constituent in melt granulation which are easy to produce, ensure very good and long-lasting release of the sulfur granulates, are very readily water-soluble, result in spherical melt granulates without fragile edges and do not form, even over a sustained period, stubborn residues on the apparatus, in particular the steel cooling belt, having an adverse effect on release or process operation.

A further object of the present invention is especially that of providing compounds for use as release agents or release agents constituents in melt granulation which are producible from fewer raw materials and thus more easily producible than the polyether siloxanes hitherto employed for this purpose.

It has now been found that, surprisingly, the use of polyether siloxanes comprising less than 20 silicon atoms as a release agent or release agent constituent in melt granulation achieves this object.

These polyether siloxanes are adsorbed onto the sulfur granulates and thus ensure good release of the melt granulates even though they comprise fewer silicon atoms than the polyether siloxanes hitherto used for this purpose. This is especially surprising since it has hitherto been assumed that only long-chain polysiloxanes having a high number of silicon atoms, such as the above-described silicone oils or polyether siloxanes of the prior art, would achieve a sufficient release agent effect in the melt granulation.

The present invention therefore firstly provides for the use of at least one polyether siloxane having less than 20 silicon atoms as a release agent or a release agent constituent in melt granulation.

The present invention correspondingly also provides a process for producing melt granulates, characterized in that the at least one polyether siloxane is used as a release agent or release agent constituent.

The present invention yet further provides melt granulates obtainable via the use according to the invention and/or by the process according to the invention.

Advantageous configurations of the subject-matter of the invention are apparent from the claims, the examples and the description. Furthermore, it is explicitly pointed out that the disclosure relating to the subject-matter of the present invention includes all combinations of individual features of the present or subsequent description of the invention and of the claims. More particularly, embodiments of one subject of the invention are also applicable mutatis mutandis to the embodiments of the other subjects of the invention.

One advantage of the polyether siloxanes to be employed according to the invention compared to the polyether siloxanes from EP 2543630 A1 or to the polyether siloxane Tegopren® 5863 is that they need not be produced from different polyethers and are thus easier to produce. The inventors have surprisingly shown that such polyether siloxanes which comprise only a small number of silicon atoms are suitable as a release agent or release agent constituent in melt granulation even if they do not comprise different polyether radicals.

Without wishing to be bound to any theory it is thought that polyether siloxanes having a relatively high number of silicon atoms must, on account of the associated strong hydrophobicity of the polysiloxane portion, bear special and also different polyether radicals as hydrophilic counterparts to achieve a good hydrophilic-lipophilic balance (HLB).

The invention further has the advantage that the melt granulates exhibit a virtually perfect spherical shape and thus have no edges or flat, fragile regions that could break during further processing/packaging. Dusts and irregularly shaped bodies are therefore avoided, thus allowing clean processing and precise dosing of the melt granulates.

Another advantage of the invention is that the water solubility of the polyether siloxanes considerably simplifies the use and cleaning of the granulation apparatuses. The water solubility also achieves the effect that the release agent may be applied to the steel belt in virtually any desired thickness by varying the concentration of the polyether siloxane in the aqueous solution and the amount of the solution applied to the steel belt as release agent.

A further advantage of the invention is that the no residues whatsoever remain on the steel belt when using the polyether siloxanes as a release agent or release agent constituent in the melt granulation.

The subject matter of the invention will be now be described by way of example without any intention that the invention be restricted to these illustrative embodiments. Where ranges, formulae, or classes of compound are specified below, these are intended to encompass not only the corresponding ranges or groups of compounds mentioned explicitly, but also all subranges and subgroups of compounds that can be obtained by extracting individual values (ranges) or compounds. Where documents are cited in the context of the present description, the entire content thereof, particularly with regard to the subject-matter that forms the context in which the document has been cited, is intended to form an integral part of the disclosure content of the present invention. In the case of compositions, the percentage figures are based on the overall composition unless otherwise stated. Where figures are hereinbelow reported in percent these percentages are percentages by weight unless otherwise stated. Where measurements or physical properties are hereinbelow reported these are measurements or physical properties measured at 25° C. and preferably at a pressure of 101 325 Pa (standard pressure) and preferably a relative air humidity of 50% unless otherwise stated. The number-average molecular weight MN is determined by gel permeation chromatography (GPC) according to the standard DIN 55672:2016, preferably according to the standard DIN 55672-1:2016. Wherever molecules/molecule fragments have one or more stereocentres or can be differentiated into isomers on account of symmetries or can be differentiated into isomers on account of other effects, for example restricted rotation, all possible isomers are encompassed by the present invention. Specific embodiments are defined hereinbelow and so features such as indices or structural constituents can be subject to restrictions by virtue of the embodiment. For all features unaffected by the restriction, the remaining definitions each remain valid. The word fragment “poly” in the context of the present invention encompasses not just compounds having at least 2 repeating units of one or more monomers in the molecule but preferably also compositions of compounds having a molecular weight distribution and having an average molecular weight of at least 200 g/mol. This definition takes account of the fact that it is customary in the field of industry in question to refer to such compounds as polymers even if they do not appear to conform to a polymer definition as per OECD or REACH guidelines. The polyether siloxanes described in the context of the invention may comprise various structural units two or more times. These repeating units may be present in these compounds in either an unordered, for example randomly distributed, or ordered arrangement. The repeating units marked with indices in the following formulae (I), (II), (III), (IV) and (V) may thus be distributed in random or blockwise fashion and may also be distributed alternatingly or may form a gradient along the chain, where one is present; in particular they can also form any mixed forms in which groups having different distributions may optionally follow one another. Any permutation of the repeating units is thus encompassed in the following formulae (I), (II), (III), (IV) and (V). The divalent units (OC₂H₃R³) in formulae (II) and (III) and [CH₂CH(CH₃)O] in formulae (IV) and (V) may be bonded to the adjacent groups or atoms differently. In formula (II) and formula (III), (OC₂H₃R³) is in each case independently a radical of the form [CH₂CH(R³) O] and/or of the form [CH(R³)CH₂O] but preferably a radical of the form [CH₂CH(R³) O]. Correspondingly [CH₂CH(CH₃) O] in the formulae (IV) and (V) is in each case independently a radical of the form [CH₂CH(CH₃) O] and/or of the form [CH(CH₃)CH₂O], but preferably a radical of formula [CH₂CH(CH₃) O]. Formulae (I), (II), (III), (IV) and (V) describe compounds formed from repeating units, for example repeating fragments, blocks or monomer units, and may have a molar weight distribution. The frequency of the repeating units is indicated by indices. The indices a, b, c, d, c(1), c(2), c(3), c(4) used in the formulae may be both natural numbers ≥0 and non-rational numbers ≥0, in each case of course only in the defined ranges. In the first case the indices refer to the frequency of the repeating units in a single polymer as is present for example as part of a polymer mixture and in the second case to the frequency of the repeating units expressed as an arithmetic average (number-average) based on the entirety of the polymers in a mixture. This is intended to take into account that polymers are typically only present in mixtures on account of their molar mass distribution. In the latter case the employed indices a, b, c, d, c(1), c(2), c(3), c(4) and also the value ranges of the specified indices are thus understood to mean the average values of the possible distribution of the actual structures present and/or mixtures thereof. The polyether siloxanes to be used according to the invention are preferably in the form of equilibrated mixtures. Specific embodiments may have the effect that statistical distributions are restricted as a consequence of the embodiment. For all regions unaffected by the restriction, the statistical distribution is unchanged.

The term “unsaturated” describes the presence of one or more carbon-carbon triple bonds and/or carbon-carbon double bonds that are not part of an aromatic ring.

The terms melt granulate, granulate, pellet and pastille are understood as being synonymous in the context of the present invention. Briquettes shall be understood to mean a granulate/granular material in the context of the present invention. The terms melt granulation and melt pelletization hereinbelow shall be considered in the context of the present invention to be covered by the collective term melt granulation.

The terms polyether siloxane, polyether polysiloxane, polyether-modified siloxane, polyether-modified polysiloxane are understood as being synonymous terms in the context of the present invention.

As is elucidated hereinabove the use according to the invention has the feature that polyether siloxanes having less than 20, preferably 3 to 5, in particular 3 to 4, silicon atoms are employed as a release agent or release agent constituent in the melt granulation.

It is thus preferred for example when the polyether siloxanes comprise at least 3 and at most 4, 5, 6, 7, 8, 9, 10, 11, 12, 13, 14, 15, 16, 17, 18 or 19 silicon atoms, wherein a smaller number of silicon atoms is preferred over a greater number.

A polyether siloxane is understood to mean a compound comprising organic radicals bonded to silicon atoms and structural units of the formula ≡Si—O—Si≡, where “≡” represents the three remaining valencies of the silicon atom in question and where at least one organic radical comprises a polyether radical. It is preferable when the polyether-modified siloxanes are compounds composed of units selected from the group consisting of M=[R¹₃SiO_{1/2}], D=[R¹₂SiO_{2/2}], T=[R¹₁SiO_{3/2}] and optionally additionally have units of the formula Q=[SiO_{4/2}], where R¹ is a monovalent organic radical and at least one radical R¹ is a monovalent polyether radical R² and all remaining radicals R¹ are monovalent hydrocarbon radicals R. The radicals R¹ or R and R² may in each case be selected independently and are identical or different when compared in pairs.

It is further preferable when the at least one polyether siloxane is a compound of formula (I)

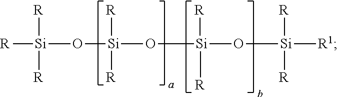

where:
R is in each case independently selected from the group consisting of monovalent hydrocarbon radicals having 1 to 10 carbon atoms, preferably in each case independently selected from the group consisting of methyl, ethyl, propyl and phenyl, especially methyl;
R¹ is in each case independently selected from the group consisting of R and R², preferably R, especially methyl;
R² is in each case independently selected from the group consisting of monovalent polyether radicals of formula (II)

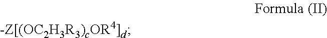

Z is in each case independently selected from the group consisting of (d+1)-valent hydrocarbon radicals that are optionally interrupted by oxygen atoms and have 2 to 10, preferably 3 to 4 and especially 3 carbon atoms;
R³ is in each case independently selected from the group consisting of H and monovalent hydrocarbon radicals having 1 to 8 carbon atoms, preferably in each case independently selected from the group consisting of H, methyl, ethyl and phenyl, especially in each case independently selected from the group consisting of H and methyl;
R⁴ is in each case independently selected from the group consisting of H, monovalent hydrocarbon radicals having 1 to 8 carbon atoms and acyl radicals having 1 to 8 carbon atoms, preferably in each case independently selected from the group consisting of H, methyl and acetyl, especially H;
a=0 to 2, preferably 0 to 1, especially 0;
b=1 to 3, preferably 1 to 2, especially 1;
c=2 to 100, preferably 3 to 50, especially 4 to 30;
d=1 to 3, preferably 1 to 2, especially 1;
with the proviso that:
a+b=1 to 3, preferably 1 to 2, in particular 1.

Formula (I) encompasses every permutation of the units whose number is indicated by the indices a and b respectively. The units may have a random distribution or be arranged in a gradient or in blocks. However, it is preferable when the units have a random distribution since the polyether siloxanes are preferably produced from equilibrated SiH-functional siloxanes.

Formula (II) encompasses every permutation of the units whose number is indicated by the index c. The units of formula (II) may thus have a random distribution or be arranged in a gradient or in blocks.

Indices a, b, c, and d may be natural numbers or arithmetic averages. It is preferable when the indices are natural numbers.

It is also preferable for the at least one polyether siloxane that: R=methyl, Z=—CH₂CH₂CH₂—, R⁴=H and d=1.

It is preferable when the divalent polyether radicals (OC₂H₃R³)_{c} are in each case independently selected from radicals of formula (III)

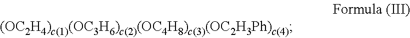

where:
Ph is phenyl;
where:
c(1)=1 to 100, preferably 2 to 50, especially 4 to 30;
c(2)=0 to 70, preferably 1 to 40, especially 2 to 20;
c(3)=0 to 5, preferably 0 to 2, especially 0;
c(4)=0 to 5, preferably 0 to 2, especially 0;
with the proviso that:

$$c ( 1 ) + c ( 2 ) + c ( 3 ) + c ( 4 ) = c .$$

Formula (III) encompasses every permutation of the units in the radical of formula (III) whose number is indicated by the indices c(1), c(2), c(3) and (c4). The units of formula (III) may thus have a random distribution or be arranged in a gradient or in blocks.

Indices c(1), c(2), c(3) and (c4) may be natural numbers or arithmetic averages. It is preferable when the indices are natural numbers.

It is preferable when in formula (III) the units marked with index c(1) are those derived from ethylene oxide, the units marked with index c(2) are those derived from propylene oxide, the units marked with index c(3) are those derived from butylene oxide and the units marked with index c(4) are those derived from styrene oxide.

It is accordingly preferable when the monovalent polyether radical R² of formula (II) comprises one or more divalent polyether radicals of formula (III) that are based on ethylene oxide, propylene oxide, butylene oxide and/or styrene oxide or mixtures thereof.

It is particularly preferable when the monovalent polyether radical R² of formula (II) comprises exactly one divalent polyether radical of formula (III), wherein this polyether radical is based on ethylene oxide, propylene oxide, butylene oxide and/or styrene oxide or mixtures thereof.

It is particularly preferable when the monovalent polyether radical R² of formula (II) comprises one or more divalent polyether radicals of formula (III) that are based on ethylene oxide and/or propylene oxide but not on butylene oxide and styrene oxide. It is thus particularly preferable when: c(3)=c(4)=0. This further improves the solubility of the polyether siloxane in water.

Here too it is particularly preferable when the monovalent polyether radical R² of formula (II) comprises exactly one divalent polyether radical of formula (III), wherein this polyether radical is based on ethylene oxide and/or propylene oxide but not on butylene oxide and styrene oxide. Here too it is thus preferable when: c(3)=c(4)=0.

It is preferable when R² is in each case independently selected from radicals of formula CH₂CH₂CH₂O [C₂H₅O]_{c(1)}[CH₂CH(CH₃) O]_{c(2)}R⁴, where R⁴ is in each case independently selected from the group consisting of H, methyl and acetyl but in particular R⁴=H. The corresponding polyether siloxane is obtainable for example by hydrosilylation of a terminally unsaturated polyether of formula CH═CHCH₂O[C₂H₅O]_{c(1)}[CH₂CH(CH₃) O]_{c(2)}R⁴ with an SiH-functional siloxane, wherein R⁴ is naturally the same way as aforementioned the radicals of formula-defined in for CH₂CH₂CH₂O[C₂H₅O]_{c(1)}[CH₂CH(CH₃) O]_{c(2)}R⁴. Thus, R² preferably derives from a terminally unsaturated polyether of formula CH═CHCH₂O[C₂H₅O]_{c(1)}[CH₂CH(CH₃) O]_{c(2)}R⁴, where the polyether is in turn obtainable from the reaction of ethylene oxide and optionally propylene oxide with allyl alcohol.

It is further preferable when the number of oxyethylene groups (OC₂H₄) to the number of (OC₂H₃R³) groups where R³≠H in the polyether siloxane is in a quantity ratio of 0.5 to 20, preferably of 0.6 to 10, especially of 0.8 to 6. It is thus preferable when: c(1)/(c(2)+c(3)+c(4))=0.5 to 20, preferably 0.6 to 10, especially 0.8 to 6. This has the advantage that the solubility of the polyether siloxane in water is further improved. It is correspondingly also preferable when the mass fraction of oxyethylene groups (OC₂H₄) based on the total mass of all (OC₂H₃R³) groups in the polyether siloxane is from 20% to 100%, preferably from 30% to 90%, in particular from 40% to 80%.

It is preferable when the number-average molecular weight MN of R² is from 200 g/mol to 2500 g/mol, preferably from 400 g/mol to 2000 g/mol, especially from 500 g/mol to 1500 g/mol. The number-average molecular weight MN of R² is defined as the number-average molecular weight MN of the corresponding unsaturated polyether used in the production of the polyether siloxane and is determined by gel permeation chromatography (GPC) according to the standard DIN 55672:2016, preferably according to the standard DIN 55672-1:2016.

It is further preferable when the divalent polyether radical (OC₂H₃R³)_{c} or the polyether radical R² calculated without the radical Z and without the radical OR⁴ has a molar mass M(PE) of 140 g/mol to 2460 g/mol, preferably of 360 g/mol to 1940 g/mol, especially of 440 g/mol to 1460 g/mol. The molar mass M(PE) is calculated according to the equation:

$$M ( PE ) = 44 g / {mol}^{*} c ( 1 ) + 58 g / {mol}^{*} c ( 2 ) + 72 g / {mol}^{*} c ( 3 ) + 120 g / {mol}^{*} c ( 4 ) ,$$

where c(1), c(2), c(3) and c(4) relate to the indices in formula (III).

Z is in each case independently selected from the group consisting of (d+1)-valent hydrocarbon radicals that are optionally interrupted by oxygen atoms and have 2 to 10, preferably 3 to 4 and especially 3 carbon atoms. It is further preferable when Z is a divalent or trivalent radical. Z is preferably selected from the group consisting of:

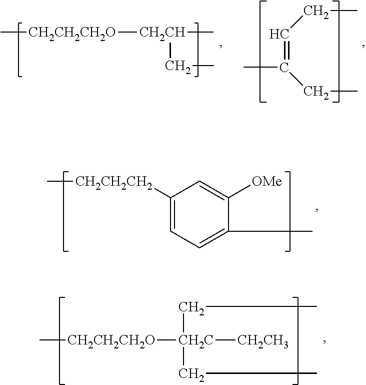

—CH₂CH(CH₃)CH₂—, —CH₂CH₂CH(CH₃)—, —CH₂CH₂C(CH₃)₂—, —CH₂CH₂CH₂—, —CH₂CH₂—;
further preferably selected from the group consisting of:

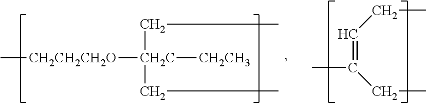

and —CH₂CH₂CH₂—;
especially —CH₂CH₂CH₂—;
where the radicals Z in the representation selected above are bonded to a silicon atom of the siloxane structure on the left and to one or two radicals of formula (OC₂H₃R³)_{c}OR⁴ according to formula (I) on the right.

It is particularly preferable to use at least one polyether siloxane of formula (IV),

Me₂SiO[SiMe₂O]ₐ[SiMeR²O]_{b}SiMe₃ Formula(IV)
where
R²=in each case independently selected from monovalent radicals of the formula—CH₂CH₂CH₂O[C₂H₅O]_{c(1)}[CH₂CH(CH₃) O]_{c(2)}R⁴;
R⁴=in each case independently selected from the group consisting of H, methyl and acetyl, in particular R⁴=H;
a=0 to 2, preferably 0 to 1, especially 0;
b=1 to 3, preferably 1 to 2, especially 1;
c(1)=1 to 100, preferably 2 to 50, especially 4 to 30;
c(2)=0 to 70, preferably 1 to 40, especially 2 to 20;
with the proviso that the conditions (i) and (ii) are met:
(i) a+b=1 to 3, preferably 1 to 2, in particular 1;
(ii) c=c(1)+c(2)=2 to 100, preferably 3 to 50, in particular 4 to 30;
as a release agent or release agent constituent in the melt granulation, wherein the indices a, b, c(1), c(2) are as defined in formula (I), (II) or (III).

It is very particularly preferable to use at least one polyether siloxane of formula (V),

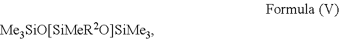

where
R²=in each case independently selected from monovalent radicals of the formula—CH₂CH₂CH₂O[C₂H₅O]_{c(1)}[CH₂CH(CH₃) O]_{c(2)}R⁴;
R⁴=in each case independently selected from the group consisting of H, methyl and acetyl, in particular R⁴=H;
c(1)=1 to 100, preferably 2 to 50, especially 4 to 30;
c(2)=0 to 70, preferably 1 to 40, especially 2 to 20;
with the proviso that:
c=c(1)+c(2)=2 to 100, preferably 3 to 50, in particular 4 to 30;
as a release agent or release agent constituent in the melt granulation, wherein the indices a, b, c(1), c(2) are as defined in formula (I), (II) or (III).

It is preferable when the polyether siloxanes to be used according to the invention have a cloud point of greater than 30° C. The cloud point can be determined as for mineral oil products according to standard DIN EN 23015:1994-05 or standard DIN EN ISO 3015:2018-04.

It is preferable when the polyether siloxanes used are largely or completely biodegradable. Biodegradability here is preferably determined by the OECD 301 F method. More preferably, biodegradability is determined in accordance with OECD 301 F after 28 days at 22° C. Further preferably, biodegradability is determined as in EP 3106033 A1, especially as described in the examples therein. It is preferable when the polyether siloxanes have a biodegradability of not less than 60%, especially of not less than 65%, the maximum value being 100%.

The polyether-modified siloxanes may be obtained for example in the manner known to those skilled in the art from the corresponding unsaturated polyethers and the corresponding SiH-functional siloxanes by hydrosilylation. The preferably employed process for producing the polyether siloxanes is a transition metal-catalysed hydrosilylation of the unsaturated polyethers with SiH-functional siloxanes to form Si—C linkages, as described for example in EP 1520870, EP 1439200, EP 1544235, U.S. Pat. Nos. 4,147,847, 4,025,456, EP 0493836 or U.S. Pat. No. 4,855,379 and the documents cited therein. Preference is given to using a platinum catalyst for catalysis of the hydrosilylation.

Production of the unsaturated polyethers employed in the context of the hydrosilylation, on which the radicals of formula (II) and (III) are based, preferably allyl polyethers, is likewise known from the prior art. For example, EP 1360223 and the documents cited therein describe the preparation of unsaturated polyethers with and without derivatization of the OH functionality. U.S. Pat. Nos. 5,877,268 and 5,856,369 describe the preparation of allyl-started polyethers using DMC catalysis. DE 19940797 describes the preparation and use of polyalkylene oxides using potassium methoxide as catalyst. Further processes are described in U.S. Pat. Nos. 3,957,843, 4,059,605, 3,507,923, DE 102005001076 and DE 3121929.

Production of polyethers is preferably carried out by reacting a starter alcohol, which is preferably allyl alcohol, with ethylene oxide and/or propylene oxide. The polymerization of the alkylene oxides may be performed neat or in any desired mixtures. The sequence of the addition reaction steps may be as desired to obtain, depending on the procedure, unsaturated polyethers having a random, block or gradient arrangement.

Particularly suitable polyether siloxanes are described in EP 3106033 A1 and WO 2016/202564 A1. Reference is expressly made to the aforementioned documents with regard to the employed polyether siloxanes.

The polyether siloxanes according to the invention may be used as a release agent themselves or else as a release agent constituent of a release agent. When the polyether siloxanes are employed as a release agent constituent the employed release agent is preferably a mixture or solution of the polyether siloxanes in a solvent. The solvent may be water or an organic solvent. Alcohols, especially ethanol, are preferred as organic solvents. It is particularly preferable when the polyether siloxanes are employed in the form of aqueous solutions. It is therefore preferably to employ a composition containing or consisting of the at least one polyether siloxane and water as the release agent. It is preferable when the mass fraction of the at least one polyether siloxane in the release agent is from 0.5% to 50%, preferably 5% to 30%, in particular 10% to 20%. The aqueous solutions particularly employed as release agents therefore preferably comprise from 0.5 to 50% by weight, preferably from 1% to 25% by weight, and very particularly preferably from 3% to 18% by weight of polyether siloxanes.

The polyether siloxanes employed are particularly advantageously “superspreaders”. A superspreader reduces the surface tension of the water to an extreme degree. The superspreader thus allows extremely good wetting of surfaces with the aqueous solution containing it. It is therefore preferable when a mixture of 0.1 part by weight of the at least one polyether siloxane and 99.9 parts by weight of water exhibits a spreading area of 10 to 60 cm², preferably of 15 to 50 cm², in particular of 20 to 40 cm², on a polypropylene film. The spreading is specifically determined by applying a 50 μl droplet of the test solution onto a standard polypropylene film (for example Forco-OPPB, Van Leer). The droplet is applied with a micropipette. The area of spread is measured 90 seconds after application. The experiments are performed at 23° C. and a relative atmospheric humidity of 60%.

The polyether siloxanes used preferably have a cloud point of 30° C. to 70° C., in particular 35° C. to 60° C. The cloud point is preferably determined in accordance with DIN EN 1890. Of the processes specified therein it is preferable to employ one where 1 g of sample with 100 g of water is examined. An appropriately prepared solution is heated in a test tube/beaker until marked clouding occurs. Upon cooling in air with stirring, a thermometer is used to determine the temperature at which the solution becomes clear/remains only slightly opalescent.

The substances to be granulated may be selected for example from the group consisting of alkanesulfonate, aluminium sulfate, ammonium nitrate, ammonium phosphate, anthracene, antioxidants, antiozonant, asphalt, benzoic acid, bis(hydroxyethyl) terephthalate (BHET), bisphenol A, bitumen, caprolactam, carbazole, crotonic acid, diaminodiphenylmethane (DMA), emulsifiers, oleochemicals, photogelatin, urea, resins (e.g. acrylic resin, rosin, epoxy resin, hydrocarbon resin, phenolic resin, polyamide resin, polyester resin, silicone resin, tall oil resin), calcium stearate, cobalt naphthenate, cobalt stearate, lactam 12, fats, cocoa mass, cheese, chocolate, gelatin, chewing gum base, sauces, soup concentrates, masterbatches, naphthalene, sodium acetate, neopentyl glycol (NPG), paradichlorobenzene, pitch, pesticides, polyethylene glycol, polyethylene terephthalate (PET), polystyrene, polyvinyl acetate, powder coatings, PVC additives, PVC stabilizers, cleaning agents, soaps, synthetic hotmelt adhesives (e.g. based on ethylene vinyl acetate), polyurethane, polyamide or polyester, reactive hotmelt adhesives, sulfur, sulfur+bentonite, sorbitol, stabilizers, stearic acid, surfactants, toluene diisocyanate (TDI), triazole (BTA, TTA), trimellitic hydride (TMA), triphenyl phosphate (TPP), supercooling or supercooled melts, UV stabilizers, waxes (e.g. paraffin, AKD wax, microwax, PE wax, PP wax, beeswax, filled wax, fragrance wax, wax paints, montan wax or coating wax, detergent additives), zinc nitrate or zinc stearate. It is very particularly preferable when sulfur is the substance to be granulated. It is thus particularly preferable when sulfur is granulated in the melt granulation.

It is preferable when 0.01 to 0.04 g, preferably 0.01 to 0.03 g, in particular 0.01 to 0.02 g, of the at least one polyether siloxane is employed per kg of the substance to be granulated or per kg of melt.

The melt granulation is preferably carried out as described in U.S. Pat. Nos. 6,398,989 and 4,279,579. Reference is expressly made to the aforementioned documents with regard to the employed apparatuses and basic procedure.

The present invention further provides a process for producing melt granulates, characterized in that the at least one polyether siloxane is used in accordance with the invention as a release agent or release agent constituent.

It is preferable when the release agent is applied to a surface of a metal carrier, a melt is applied to the surface treated with the release agent, the melt is cooled until solidification and the resulting melt granulate is separated from the metal carrier. It is thus preferable when the release agent according to the invention is applied to the metal carrier before application of the melt. The application of the release agent may be effected for example by spray application of the release agent onto the metal carrier. The amount of release agent may be freely chosen within wide ranges. It is likewise preferable when the melt is applied to the metal carrier in the form of droplets. The metal carrier is preferably a steel belt. It is accordingly also preferable to employ a steel belt cooler. When using a steel belt cooler the melt of the material to be granulated is applied to the steel belt treated with the release agent, wherein the melt on the steel belt is cooled below the melting temperature/the solidification temperature and thus solidifies by a preferred means of cooling of the steel belt from below using a coolant, preferably water.

In the case where the melting temperature of the material to be granulated is above 100° C. (for example in the case of sulfur) separation of the polyether siloxanes occurs during the melt granulation through evaporation of the water. In the immediate proximity of the hot melt the polyether siloxanes precipitate out of the aqueous solution on account of the preferred cloud point in the range from 30° C. to 70° C. and are adsorbed onto the surface of the sulfur and the surface of the steel belt in extremely thin layers. They thus ensure release of the granulates and affect the shape of the melt granulates such that these preferably have a spherical shape and thus also have the least possible contact with the surface of the steel belt.

The present invention thus also further provides melt granulates obtainable by the use according to the invention of the at least one polyether siloxane and/or of the process according to the invention.

It is preferable when the mass fraction of the at least one polyether siloxane based on the total mass of the melt granulates is 1 ppm to 40 ppm, preferably 5 ppm to 30 ppm, in particular 10 ppm to 20 ppm.

The examples that follow describe the present invention by way of example without any intention to limit the invention, the scope of application of which is apparent from the entirety of the description and the claims, to the embodiments specified in the examples.

### EXAMPLES

### Production of the Polyether Siloxane According to the Invention:

A 1000 ml three-necked flask fitted with a stirrer and a reflux condenser was initially charged with 0.5 mol of a polyether of formula CH₂═CHCH₂ (OC₂H₄)₈(OC₃H₆)_{3.3}OH and heated to 90° C. Subsequently, 10 ppm of Pt were added in the form of a toluenic solution of Karstedt's catalyst (Pt content 2 mol %). The mixture was stirred for 10 min and then 0.38 mol of SiH groups in the form of the SiH-functional siloxane Me₃SiO[SiMeHO]₁SiMe₃ was added dropwise over 15 min. An exothermic reaction was observed; the reaction mixture was stirred at 90° C. for a further 4 h. In all cases, it was no longer possible to detect any SiH functions by gas-volumetric means.

### Performance Testing:

The operation of the present invention was tested in a practical test and compared to conventionally employed organomodified siloxanes and silicone oil emulsions. This employed a laboratory apparatus from IPCO containing a Rotoformer® and a water-cooled steel belt (Rotoform System). The following test conditions were observed. The employed release agent constituent was used to produce, as release agent, a 14% by weight aqueous solution/mixture which was continuously sprayed onto the steel belt. The input materials and the description of the release performance are apparent from table 1.

### Test Conditions:

Belt speed: 11.25 m/min
Rotoformer speed: 12 m/min
Sulfur temperature: 145° C.
Cooling water temperature: 22° C.
Steel belt width: 150 mm
Conveyor belt cooling length: 2.4 m
Release agent: Consumption about 0.02 g of active substance (employed as 14% by wt. aqueous
solution/mixture) per kg of sulfur

TABLE 1
Release agent constituent and test results

| Release agent constituent | Description of release performance |
|---|---|
| A 14% by weight aqueous silicone oil emulsion | No easy release, melt granulates are elliptical, |
| of a polydimethylsiloxane from Dow Corning | edges break easily. Buildup of residues of the |
| having the designation DC 200 and a viscosity | release agent. |
| of 20 cSt. | |
| An aqueous emulsion of the release agent | No easy release, melt granulates are elliptical, |
| IPAC SRB PLUS from Sabah diluted to 14% by | edges break easily. Buildup of residues of the |
| weight (the product IPAC SRB PLUS is a 75% | release agent. |
| polydimethylsiloxane emulsion). | |
| 14% by weight aqueous solution of | Initially easy release, becoming more difficult |
| TEGOPREN ® 5863 from Evonik (a long-chain | after 5 minutes. Melt granulates deviating from |
| polyether siloxane having 48 silicon atoms) | a spherical shape, more commonly flat bodies, |
| | are often obtained. |
| 14% by weight aqueous solution of the | Very easy release, no deterioration in release |
| inventive polyether siloxane from | performance after 5 minutes, no residues. Melt |
| EP2543630A1 (a long-chain polyether | granulates have a uniform spherical shape. |
| siloxane having 50 silicon atoms). | |
| 14% by weight aqueous solution of inventive | Extremely easy release, no deterioration in |
| polyether siloxane. | release performance after 5 minutes, no |
| | residues. Melt granulates have an absolutely |
| | uniform spherical shape. |

As is apparent from table 1, the inventive polyether siloxane has better properties than the release agents/release agent constituents known to date from the prior art. Inventive melt granulates have the best shape (an absolutely uniform spherical shape). This is also evident in the slightly higher internal temperature of the inventive melt granulates after their production compared to the noninventive melt granulates since the virtually perfect shape of the inventive melt granulates has the result that the contact area with the cooling belt is minimal.

1. A release agent or release agent constituent used in melt granulation, comprising:
at least one polyether siloxane having less than 20 silicon atoms.

2. The release agent or release agent constituent used in melt granulation according to claim 1, wherein the at least one polyether siloxane is a compound of Formula (I), 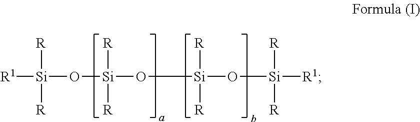
wherein:
R is in each case independently selected from the group consisting of monovalent hydrocarbon radicals having 1 to 10 carbon atoms;
R¹ is in each case independently selected from the group consisting of R and R²;
R² is in each case independently selected from the group consisting of monovalent polyether radicals of Formula (II) 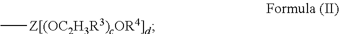
Z is in each case independently selected from the group consisting of (d+1)-valent hydrocarbon radicals that are optionally interrupted by oxygen atoms and have 2 to 10 carbon atoms;
R³ is in each case independently selected from the group consisting of H and monovalent hydrocarbon radicals having 1 to 8 carbon atoms;
R⁴ is in each case independently selected from the group consisting of H, monovalent hydrocarbon radicals having 1 to 8 carbon atoms and acyl radicals having 1 to 8 carbon atoms;
a=0 to 2;
b=1 to 3;
c=2 to 100;
d=1 to 3;
with the proviso that:
a+b=1 to 3.

3. The release agent or release agent constituent used in melt granulation according to claim 2, wherein:
R=methyl,
Z=—CH₂CH₂CH₂—,
R⁴=H,
d=1.

4. The release agent or release agent constituent used in melt granulation according to claim 2, wherein the divalent polyether radicals (OC₂H₃R³)_{c} are each independently selected from radicals of Formula (III) 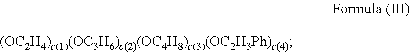
wherein:
Ph is phenyl;
wherein:
c(1)=1 to 100;
c(2)=0 to 70;
c(3)=0 to 5;
c(4)=0 to 5;
with the proviso that:
$$c ( 1 ) + c ( 2 ) + c ( 3 ) + c ( 4 ) = c .$$

5. The release agent or release agent constituent used in melt granulation according to claim 4, wherein: c(3)=c(4)=0.

6. The release agent or release agent constituent used in melt granulation according to claim 1, wherein the release agent employed is a composition containing or consisting of the at least one polyether siloxane and water.

7. The release agent or release agent constituent used in melt granulation according to claim 1, wherein a mass fraction of the at least one polyether siloxane in the release agent is from 0.5% to 50%.

8. The release agent or release agent constituent used in melt granulation according to claim 1, wherein sulfur is granulated in the melt granulation.

9. The release agent or release agent constituent used in melt granulation according to claim 1, wherein 0.01 to 0.04 g of the at least one polyether siloxane are employed per kg of melt.

10. A process, comprising:
producing of melt granulates, wherein the at least one polyether siloxane is used as a release agent or release agent constituent as specified in claim 1.

11. The process according to claim 10, wherein the release agent is applied to a surface of a metal carrier, a melt is applied to the surface treated with the release agent, the melt is cooled until solidification and the resulting melt granulate is separated from the metal carrier.

12. The process according to claim 11, wherein a steel belt is used as the metal carrier.

13. The process according to claim 10, wherein a steel belt cooler is used.

14. Melt granulates, comprising:
the release agent or release agent constituent used in melt granulation according to claim 1.

15. The melt granulates according to claim 14, wherein a mass fraction of the at least one polyether siloxane based on the total mass of the melt granulates is 1 ppm to 40 ppm.
